(19) United States
(12) Patent Application Publication
(10) Pub. No.: US 2003/0004079 A1
(43) Pub. Date: Jan. 2, 2003

(54) Method and cleaning agent for cleaning surfaces of concrete, asphalt or the like

(76) Inventors: Peter Aigner, Kottingbrunn (AT); Wolfgang Kummer, Hirtenberg (AT)

Correspondence Address: JACOBSON HOLMAN PLLC, 400 SEVENTH STREET N.W., SUITE 600, WASHINGTON, DC, 20004, US

(21) Appl. No.: 10/214,772

(22) Filed: Aug. 9, 2002

Related U.S. Application Data
(63) Continuation of application No. PCT/AT01/00032, filed on Feb. 8, 2001.

(30) Foreign Application Priority Data
Feb. 10, 2000 (AT) A 203/2000
Aug. 2, 2000 (AT) A 1343/2000

(51) Int. Cl. B08B 3/02; B08B 3/00

(52) U.S. Cl. 510/240; 134/26

(57) ABSTRACT

A method for cleaning surfaces made of concrete, asphalt or similar, especially airport runways, road surfaces, the floors of halls or similar. In order to clean and remove soiling substances, such as rubber, oil, fat, carbon particles or similar, which adhere to a surface, a cleaning agent resulting in the dissolution or detachment of said soiling substances is applied to the surface in question, whereupon a rinsing fluid, especially water, is subsequently used to rinse the surface and to remove the dissolved soiling substances therewith and collected in at least one collector. The cleaning which occurs is quick and devoid of any abrasive effect on a covering coat or wearing coat of the surface to be cleaned. The inventive cleaning agent is made of an aqueous emulsion, containing at least one upper methyl, ethyl, isopropyl carboxylate and at least one multivalent alcohol.

The present application is a continuation application of PCT/AT01/00032, filed Feb. 8, 2001.

### FIELD OF THE INVENTION

The present invention relates to a method for cleaning surfaces of concrete, asphalt or the like, in particular airport runways or road surfaces, wherein a cleaning agent is applied on the surface to be cleaned and is subsequently removed together with the dissolved dirt particles by rinsing with a rinsing fluid, in particular water, as well as a cleaning agent for cleaning surfaces of concrete, asphalt or the like, in particular airport runways or road surfaces, which cleaning agent is applied on the surface to be cleaned and subsequently removed together with the dissolved dirt particles by rinsing with a rinsing fluid, in particular water.

### DESCRIPTION OF THE PRIOR ART

From EP 0 971 012 A1, the use of oleic acid esters as well as a powdery detergent for surfaces soiled by hydrocarbons, in particular vegetable or mineral surfaces or animals, is known. That detergent is particularly suitable for the removal of heavy-oil residues on beaches, plants and animals.

From DE 35 38 539 A1, a movable device for the cleaning of road-ways is known, by which water under pressure is applied on the surface to be cleaned and sucked off again in order to be fed to purification or recycling directly in the vehicle.

In the context of cleaning surfaces of concrete, asphalt or the like such as, for instance, airport runways, road surfaces or hall floors, it is presently known and required, in particular in connection with airport runways, to regularly clean the same and remove adhering dirt particles such as, for instance, rubbed-off rubber parts, oils, greases, hydrocarbon particles from motor and jet aggregates as well as fuel emissions from the same, in order to restore the desired or required surface properties. Such a cleaning procedure or removal of deposits must be carried out on a regular base, in particular in the case of airport runways, in order to safeguard or enhance the safety of airplanes taking off and landing there.

Concerning the cleaning of such usually large areas of concrete, asphalt or the like, it is furthermore known to clean those areas and, in particular, airport runways from impurities and adhering dirt by abrasive treatment methods using water or water supplemented with cleaning agents under extremely high pressures of, for instance, more than 1500 to 2000 bars, and/or millers or steel brushes. All of those known cleaning methods have in common that, on the one hand, they require a lot of time for the cleaning of large areas and, on the other hand, they entail the risk of eliminating parts of the uppermost covering layer or wear layer of such runways or surfaces both with the use of high-pressure jets and with the application of lift-off treating methods such as, for instance, milling or treatment by means of steel brushes, so that at least the covering layers or wear layers of those surfaces will have to be completely replaced or renewed after a few cleaning procedures, which involves accordingly high costs and much time.

### SUMMARY OF THE INVENTION

The present invention aims at providing a method as well as a cleaning agent for the cleaning of such surfaces of concrete, asphalt or the like, in particular airport runways, road surfaces, hall floors or the like, wherein any abrasive working off or deterioration of the covering layer of the surface to be cleaned is avoided on account of a special method control and the cleaning agent employed. Furthermore, the present invention aims at providing a cleaning agent which, unlike known cleaning agents, is completely biodegradable and safe or harmless or without negative effects for both environment and the personnel using such a cleaning agent. Finally, the invention aims at providing a method which, unlike known methods, can be carried out at reduced time expenses.

To solve these objects, the method according to the invention for cleaning surfaces of concrete, asphalt or the like, in particular airport runways or road surfaces, departing from a method of the initially defined kind, is essentially characterized in that, for removing rubbed-off rubber parts adhering to said surface, an aqueous cleaning agent causing the dissolution or separation of said dirt particles is applied on the surface to be cleaned and upon rinsing is collected in at least one collecting tank together with said dirt particles. Due to the fact that, according to the invention, a cleaning agent is applied on the surface to be cleaned in order to clean the same and remove solid dirt particles or rubbed-off rubber parts particularly adhering to the surface, which cleaning agent is subsequently rinsed off after a comparatively short exposure time, it is ensured that an additional detachment of, or damage to, the covering layer or wear layer of the surface to be cleaned is avoided, since any deterioration of, or action on, the covering layer or protective layer of the surface to be treated is avoided by the application of the cleaning agent causing the dissolution or at least separation of the particularly adhering dirt particles. It is, thus, to be anticipated that no mechanical stresses, or elimination of elements of the uppermost covering layer of the surface to be cleaned, are effected when using the method according to the invention.

For the proper application of the cleaning agent, it is proposed according to a preferred method control that the cleaning agent is applied, particularly sprayed, on the surface to be cleaned under a pressure of at most 75 bars, in particular less than 50 bars, wherein it is safeguarded by using such a cleaning agent being under a comparatively low pressure that said cleaning agent will reliably penetrate optionally existing pores of the adhering impurities, thus ensuring an accordingly rapid and easy dissolution or separation of the same. Due to the comparatively low pressures used, it is, moreover, ensured that no mechanical stress will be exerted on the soil to be cleaned as happened by contrast with known methods, which operated at considerably higher pressures.

After the action of the cleaning agent and the thus caused dissolution or separation of the dirt particles to be removed, it is proceeded according to another preferred embodiment in that the removal of the cleaning agent and the dirt particles is effected by applying, in particular spraying, water under a pressure of at most 75 bars, in particular under a pressure of between 50 and 60 bars. Similar to the application of the cleaning agent under a comparatively low pressure, the method according to the invention also provides the rinsing with water under a comparatively low pressure sufficient for the removal of the cleaning agent along with the dirt dissolved therein or separated, so that not only the proper removal of the cleaning agent plus dirt is ensured but also any mechanical interference with, or abrasion of, the uppermost covering layer of the surface to be treated is prevented.

Due to the fact that both the cleaning agent and the rinsing agent, in particular water, are applied or used at comparatively low pressures, it is also feasible as opposed to known methods to use accordingly simple and hence cost-effective devices or aggregates which comprise structures simplified in view of high-pressure applications, to obtain the low operating pressures sufficient according to the invention.

In order to enable the proper and reliable removal of the cleaning agent with the dirt particles absorbed, it is proposed according to another preferred embodiment that hot water having a temperature of between 45 and 70° C., in particular about 50° C., is used to remove said cleaning agent and dirt particles. In order to shorten the time of exposure to the cleaning agent, which is required to separate and dissolve the dirt to be removed, it is, moreover, proposed that the cleaning agent is applied at a temperature of between 30 and 60° C., in particular 40 to 45° C., as in correspondence with a further preferred embodiment of the method according to the invention.

In order to ensure as rapid a treatment as possible even of large surfaces, it will suffice, using the method according to the invention, that the cleaning agent after its application on the soiled surface is allowed to act for a period of at most 30 minutes, in particular about 5 to 15 minutes, as in correspondence with a further preferred embodiment of the method according to the invention.

As mentioned in the beginning, the present invention not only aims to provide a method for cleaning surfaces of concrete, asphalt or the like, by which the treatment or cleaning of such surfaces is feasible without causing any mechanical abrasion of the latter, but also provides a cleaning agent of the initially mentioned type for the cleaning of surfaces of concrete, asphalt or the like so as to meet the objects pointed out above, which cleaning agent is essentially characterized in that, for removing rubbed-off rubber parts adhering to said surface, the cleaning agent is comprised of an aqueous emulsion containing at least one higher methyl, ethyl, isopropyl carboxylate and at least one polyvalent alcohol. Such a cleaning agent is, thus, produced substantially on an organic base, having a biochemical structure and composition, and can therefore be readily used while complying with the respective guidelines calling for complete biological degradability such that the use of the cleaning agent according to the invention is safe also in the open or beside greens and even cleaning agent possibly penetrating the ground or soil beside surfaces to be cleaned do not have any impact on the environment. In addition, the cleaning agent according to the invention can be produced in an accordingly simple and cost-effective manner and optionally tuned to different purposes of use like, for instance, different known types of dirt to be removed.

On account of the composition of the cleaning agent according to the invention, it is ensured that the grounds to be cleaned, in particular concrete runways or asphalt roads, will not be chemically attacked and hence damaged, and that it is feasible, by using said cleaning agent to clean surfaces of concrete, asphalt or the like, to operate at reduced pressures and comply with the procedural guidelines and environmental standards regulating the use of such a cleaning agent, without entailing the risk of an excessive evaporation or decomposition of the cleaning agent during the conditions of use, and hence the risk of contamination of the environment.

In order to achieve appropriate cleaning effects within comparatively short periods of time, it is proposed according to a preferred embodiment of the invention that the higher methyl, ethyl, isopropyl carboxylates contained in the cleaning agent according to the invention are present in the emulsion in amounts ranging from 2 to 80% by weight. By using said preferred amounts of higher methyl, ethyl, propyl and/or isopropyl carboxylates, it is ensured that the period of time required to clean the respective surfaces is kept as short as possible, on the one hand, and the chemical dissolution or separation of the impurities from the surface is guaranteed, on the other hand.

In order to avoid excessive stress on the surface to be cleaned, or any other chemical reactions than those proceeding with the impurities of the respective surface, the polyvalent alcohols contained in the cleaning agent according to the invention are selected from glycerol, ethylene glycol, propylene glycol, 1,4-butanediol and 2,3-butanediol, wherein, according to a preferred further development of the invention, the polyvalent alcohols are contained in amounts ranging from 3 to 25% by weight of the emulsion. By using said polyvalent alcohols in amounts of from 3 to 25% by weight, the environmental safety of the cleaning agent according to the invention is further enhanced, and it can be additionally safeguarded that the personnel charged with the cleaning work will not be injured or affected in terms of health even in the event of an improper handling of the cleaning agent.

According to a particularly preferred embodiment, a selection of the components for the cleaning agent according to the invention is made to the effect that the higher methyl, ethyl, isopropyl carboxylates are selected from fatty acid methyl esters, in particular rapeseed oil methyl ester, cottonseed oil methyl ester, linseed oil methyl ester and olive oil methyl ester, stearic acid methyl ester, palmitic acid methyl ester, arachinic acid methyl ester, linoleic acid ethyl ester, oleic acid methyl ester, ricinoleic acid methyl ester, stearic acid ethyl ester, palmitic acid ethyl ester, myristic acid ethyl ester, lauric acid propyl ester and stearic acid isopropyl ester.

By selectively choosing the respective carboxylates and/or carbonic acid esters, the biodegradability of the cleaning agent is ensured on the one hand, and it is safeguarded on the other hand that no irreversible contamination of the environment will occur even after cleaning agent has passed out into the environment and hence all legal requirements relating to the use of a cleaning agent in the open are met. Moreover, the specific selection of the carbonic acid esters used safeguards the virtually complete biological degradation of the cleaning agent within a very short time, for instance within a few weeks or days, so that no special additional safety precautions are required when using the cleaning agent according to the invention.

In order to improve the dissolution properties of the cleaning agent according to the invention on surfaces of concrete, asphalt or the like, for the impurities of these surfaces such as, for instance, rubbed-off rubber, escaped fuels or the like, the cleaning agent according to the invention contains 5 to 20% by weight of a monovalent alcohol, in particular ethanol, propanol or isopropanol. By the addition of monovalent alcohols both the dissolution properties as such of the cleaning agent, for the impurities to be separated or removed from surfaces of concrete, asphalt or the like and the miscibility of the solvent with water can be improved so as to provide a more stable emulsion capable of de-emulsifying more slowly, thus improving also the working time of the cleaning agent.

In order to improve the cleaning performance of the cleaning agent according to the present invention, the cleaning agent according to a particularly preferred embodiment additionally contains soaps, in particular potash soaps, in amounts of less than 10% by weight, in particular 3 to 8% by weight, wherein said soaps, according to another preferred further development aimed to improve the cleaning performance of the soaps contained in the cleaning agent, are contained in the form of aqueous soap solutions in amounts of from 4 to 25% of the cleaning agent. The preparation of a soap solution and the admixture of the solution to the cleaning agent ensure that the soaps contained in the cleaning agent are contained in the dissolved state and hence ready for use, thus improving the cleaning performance even further.

In order to achieve improved wetting of the concrete, asphalt or the like surfaces to be cleaned, the cleaning agent according to a preferred further development additionally contains a detergent, in particular a biodegradable nonionic detergent, in an amount of from 3 to 10% by weight.

According to a preferred further development of the cleaning agent according to the invention, a mixture of soaps and detergents is used, particularly in amounts of between 6 and 20% by weight, whereby a stable mixture or solution of the aqueous phase of the cleaning agent according to the invention, which is present in the form of an emulsion, can be obtained so as to reliably avoid the de-mixing or incomplete dissolving of the components of the aqueous phase upon application of the cleaning agent according to the invention on the surfaces to be cleaned, the cleaning performance of the cleaning agent according to the invention, thus, being further improved.

In order to obtain a stable and uniform emulsion, which can be stored also over extended periods of time, it is moreover preferably provided for the cleaning agent according to the invention that it additionally contains natural emulsifiers such as, for instance, lecithin in an amount of less then 7% by weight.

In order to further improve the cleaning effect, it is provided according to a particularly preferred embodiment that the cleaning agent additionally contains alkali and/or earth alkali alcoholates such as, for instance, potassium ethylate in an amount of from 20 to 30% by weight, in particular about 25% by weight, it being preferably provided in addition that the cleaning agent additionally contains soaps in amounts of less than 10% by weight, in particular about 5% by weight.

With the cleaning agent according to the invention an almost completely biodegradable cleaning agent is provided, which can be referred to as a natural product on account of its ingredients and which renders feasible short working times and hence short closing times of the surfaces to be cleaned.

Moreover, the process control according to the invention renders feasible the use of simplified devices, in particular, by requiring no special aggregates to attain the maximum pressures necessary in the prior art.

As already mentioned several times, the use of both the method according to the invention and the cleaning agent according to the invention offers the additional advantage that the surface layer or uppermost covering layer or wear layer of the surfaces to be cleaned will be attacked and hence removed or damaged neither mechanically, for instance by the application of high pressures, nor chemically by the cleaning agent, so that the regular renewals of at least the uppermost covering layer or wear layer of, for instance, an airport runway, which are required in the known methods, can be omitted too.

Description of Preferred Embodiments

The present invention will be explained in more detail by way of exemplary compositions of the cleaning agent according to the invention:

### EXAMPLE 1

| | |
|---|---|
| Stearic acid methyl ester | 70% |
| Ethyl alcohol | 10% |
| Lecithin | 5% |
| Glycerol | 5% |
| Detergent | 5% |
| Potash soap + water | 5% |
| | 100% |

A cleaning agent of this type enables the rapid and complete cleaning of surfaces of concrete, asphalt or the like, whereby not only surface impurities could be completely separated and removed, but also cleaning agent components that passed out into surrounding greens were biologically degraded 99.8% within two weeks such that any pollution of, or damage to, the environment could be safely excluded.

### EXAMPLE 2

| | |
|---|---|
| Stearic acid methyl ester | 50.0% |
| Potash soap | 3.5% |
| Lecithin | 5.0% |
| Detergent | 1.5% |
| Propylene glycol | 21.0% |
| Water | 19.0% |
| | 100.0% |

This cleaning agent served to perfectly clean the surface to be cleaned, namely an airport runway in the instant case, by the application of the cleaning agent under pressure and an exposure time of about 15 minutes, the cleaning agent having been rinsed off with water after its application and action. This cleaning agent allowed the separation of dirt in an equally efficient manner as the cleaning agent of Example 1, yet the dissolution of the same was poorer and slower. The cleaning agent was biodegradable almost completely within seven days.

The following general physicochemical data were obtained for the cleaning agent according to this example: aqueous emulsion of light-brown colour having a sweetish-soapy odour, a pH of 9.5 to 10, a density of 0.95 to 1.5, a boiling point of 110° C., an ignition point of 120° C.

According to the safety-handling data sheet established for this product in accordance with the respective EU regulations, no protective measures need be taken for the handling personnel, and the storage of the product in a closed container at room temperature is considered sufficient.

### EXAMPLE 3

| | |
|---|---|
| Stearic acid methyl ester | 50.0% |
| Potash soap | 7.0% |
| Lecithin | 5.0% |
| Nonionic detergent | 3.0% |
| Ethyl alcohol | 10.0% |
| Glycerol | 10.0% |
| Water | 15.0% |
| | 100.0% |

By the aid of the cleaning agent of this example, the complete removal of impurities on an airport runway was feasible by applying the cleaning agent under a pressure of approximately 50 to 60 bars and allowing it to act for 10 minutes. After rinsing with water, no visible impurities were present on the airport runway.

### EXAMPLE 4

10% by wt. fatty acid methyl ester (rapeseed oil methyl ester)

25% by wt. potassium ethylate

30% by wt. glycerol

5% by wt. potash soap

30% by wt. water

For a cleaning agent according to the invention, the following general chemo-physical data are obtained for compositions within the ranges indicated above:

| | |
|---|---|
| Aspect | greenish |
| Density (g/cm³) | 0.95-1.05 |
| pH | 8.5-10 |
| Ignition point (° C.) | above 120° C. |
| Inflammation temperature (° C.) | above 120° C. |

A cleaning agent of the above-mentioned composition is, for instance, applied under a pressure of 50 bars on an airport runway onto the surface to be cleaned, whereupon the removal of the cleaning agent and the dirt particles dissolved and separated can be effected by spraying water under a pressure of approximately 50 to 60 bars and collecting the cleaning water as well as the removed mixture of cleaning agent and separated dirt particles into a collecting tank after an exposure time of about 10 minutes. It is immediately apparent that it is feasible to clean even large surfaces in this manner at short operating cycles such that the closing times of surfaces to be cleaned can be kept accordingly short.

To sum up, it should be noted that the best cleaning performance was achieved with the cleaning agent according to Example 1, that the composition according to Example 2 appeared to be best biodegradable, and that the compositions according to Examples 3 and 4 each offered both a complete biodegradability and an excellent cleaning performance, whereby the application pressure had to be raised as compared to that used in Examples 1 and 2.

1. A method for cleaning surfaces of concrete, asphalt or the like, in particular airport runways or road surfaces, wherein a cleaning agent is applied on the surface to be cleaned and is subsequently removed together with the dissolved dirt particles by rinsing with a rinsing fluid, in particular water, wherein, for removing rubbed-off rubber parts adhering to said surface, an aqueous cleaning agent causing the dissolution or separation of said dirt particles is applied on the surface to be cleaned and upon rinsing is collected in at least one collecting tank together with said dirt particles.

2. A method according to claim 1, wherein the cleaning agent is applied, particularly sprayed, on the surface to be cleaned under a pressure of at most 75 bars, in particular less than 50 bars.

3. A method according to claim 1, wherein the removal of the cleaning agent and the dirt particles is effected by applying, in particular spraying, water under a pressure of at most 75 bars, in particular between 50 and 60 bars.

4. A method according to claim 1, wherein hot water having a temperature of between 45 and 70° C., in particular about 50° C., is used to remove said cleaning agent and dirt particles.

5. A method according to claim 1, wherein the cleaning agent is applied at a temperature of between 30 and 60° C., in particular 40 to 45° C.

6. A method according to claim 1, wherein the cleaning agent after its application on the soiled surface is allowed to act for a period of at most 30 minutes, in particular about 5 to 15 minutes.

7. A cleaning agent for cleaning surfaces of concrete, asphalt or the like, in particular airport runways or road surfaces, which cleaning agent is applied on the surface to be cleaned and subsequently removed together with the dissolved dirt particles by rinsing with a rinsing fluid, in particular water, wherein, for removing rubbed-off rubber parts adhering to said surface, the cleaning agent is comprised of an aqueous emulsion containing at least one higher methyl, ethyl, isopropyl carboxylate and at least one polyvalent alcohol.

8. A cleaning agent according to claim 7, wherein the higher methyl, ethyl and/or isopropyl carboxylates contained in the cleaning agent according to the invention are present in the emulsion in amounts ranging from 25% by weight to 80% by weight.

9. A cleaning agent according to claim 7, wherein the polyvalent alcohols are selected from glycerol, ethylene glycol, propylene glycol, 1,4-butanediol and 2,3-butanediol.

10. A cleaning agent according to claim 7, wherein the polyvalent alcohols are contained in the emulsion in amounts ranging from 3 to 45% by weight.

11. A cleaning agent according to claim 7, wherein the higher methyl, ethyl, isopropyl carboxylates are selected from fatty acid methyl esters, in particular rapeseed oil methyl ester, cottonseed oil methyl ester, linseed oil methyl ester and olive oil methyl ester, stearic acid methyl ester, palmitic acid methyl ester, arachinic acid methyl ester, linoleic acid ethyl ester, oleic acid methyl ester, ricinoleic acid methyl ester, stearic acid ethyl ester, palmitic acid ethyl ester, myristic acid ethyl ester, lauric acid propyl ester and stearic acid isopropyl ester.

12. A cleaning agent according to claim 7, wherein the cleaning agent additionally contains 5 to 20% by weight of a monovalent alcohol, in particular ethanol, propanol or isopropanol.

13. A cleaning agent according to any one of claim 7, wherein the cleaning agent additionally contains soaps, in particular potash soaps, in amounts of less than 10% by weight, in particular 3 to 8% by weight.

14. A cleaning agent according to claim 13, wherein said soaps are contained in the form of aqueous soap solutions in amounts of from 4 to 25% of the cleaning agent.

15. A cleaning agent according to claim 7, wherein the cleaning agent additionally contains a detergent, in particular a biodegradable nonionic detergent, in an amount of up to 7% by weight.

16. A cleaning agent according to claim 13, wherein the cleaning agent contains a mixture of soaps and detergents, particularly in amounts of from 6 to 20% by weight.

17. A cleaning agent according to claim 7, wherein the cleaning agent additionally contains natural emulsifiers such as, for instance, lecithin in an amount of less than 7% by weight.

18. A cleaning agent according to claim 7, wherein the cleaning agent additionally contains alkali and/or earth alkali alcoholates such as, for instance, potassium ethylate in an amount of up to 30% by weight.
